(19) United States
(12) Patent Application Publication
(10) Pub. No.: US 2017/0240787 A1
(43) Pub. Date: Aug. 24, 2017

(54) Energy Store For A Power Plant On The Basis Of A Phase Change Material (PCM)

(71) Applicant: Siemens Aktiengesellschaft, Muenchen (DE)

(72) Inventors: Matthias Uebler, Ursensollen (DE); Ludwig Baer, Erlangen (DE)

(73) Assignee: Siemens Aktiengesellschaft, Muenchen (DE)

(21) Appl. No.: 15/515,279

(22) PCT Filed: Sep. 21, 2015
(86) PCT No.: PCT/EP2015/071533

§ 371 Date: Mar. 29, 2017

(30) Foreign Application Priority Data
Sep. 30, 2014 (DE) 10 2014 219 808.9

(51) Int. Cl. C09K 5/06

(52) U.S. Cl. CPC C09K 5/063

(57) ABSTRACT

A latent energy store based on a change in the aggregate state of a storage medium is provided Energy can be stored in the storage medium as a melting enthalpy or as a crystallization enthalpy and the latent heat accumulator may be operated at temperatures of between 150° C. and 450° C. The storage medium may be or include an acetate of a metal and/or non-metal having a melting point in the range between 150° C. and 500° C.

### CROSS-REFERENCE TO RELATED APPLICATIONS

This application is a U.S. National Stage Application of International Application No. PCT/EP2015/071533 filed Sep. 21, 2015, which designates the United States of America, and claims priority to DE Application No. 10 2014 219 808.9 filed Sep. 30, 2014, the contents of which are hereby incorporated by reference in their entirety.

### TECHNICAL FIELD

The invention relates to a latent energy store based on a phase change material.

### BACKGROUND

Latent energy stores based on a first-order phase change (for example the transition from the solid state into the liquid state and vice versa) have for a long time been of great interest for the power station industry since, firstly, a reversible phase change occurs at constant temperature and, secondly, the latent enthalpy (enthalpy of fusion or crystallization) of the transition concerned can assume comparatively high values. Such materials are able to stabilize certain processes and/or temperature levels, particularly advantageously in the power station sector, thermally and especially enthalpically for a relatively long time. Contacting of an often hermetically encapsulated phase change material with a working medium, e.g. water and/or steam, enables the latter to be kept at constant temperature for longer, namely when the temperature of the working medium drops below a defined threshold, viz. the phase change temperature of the storage material. If the phase change material is, for instance, in the liquid state and is cooled by the working medium whose temperature is decreasing, the defined phase transition into the solid state occurs, with enthalpy of crystallization being liberated and the temperature remaining constant until solidification has been completed. In the process, the working medium experiences, provided good thermal contact is present, enthalpic and thermal stabilization. Effective thermal intermediate stores can be realized in this way.

Latent storage materials have not yet become established industrially, especially in the power station sector. Although the concepts of latent energy storage have been researched for decades on the laboratory scale, there has hitherto been a lack of industrial demonstrations of effectiveness and utility. The concept often founders on the fact that the phase change materials postulated for use have a phase change enthalpy which is too low, do not have a suitable temperature level, display unusable eutectic melting points, display pronounced supercooling in the heat recovery stage, are highly corrosive, toxic or not readily available and thus expensive.

An example of a successfully tested phase change store is a graphite-finned sodium nitrate module constructed by DLR e.V. in Carboneras in Southern Spain. The single salt used melts at 306° C. with an enthalpy of fusion or crystallization of about 177-178 kJ/kg.

A selection of latent storage materials which are usable in the medium temperature range may be found, for example, in Bauer et al., Advances in Science and Technology Vol. 74 (2010), 272-277. Here, pure substances and mixtures of the materials LiOH, LiCl, LiNO3, NaOH, NaNO3, NaNO2, KNO3, KCl, Ca(NO3)2 and ZnCl2 are proposed. These materials and/or mixtures are often expensive, highly corrosive, toxic, have low enthalpies or require absolute absence of water (of crystallization) in order to avoid chemical degradation.

A more comprehensive overview of potential latent storage materials is given by Tanaka et al. in “Preliminary Examination of Latent Heat-Thermal Energy Storage Materials, III. Screening of Eutectic Mixtures over a Range from 200° C. to 1500° C”, Bul. Electrotech. Lab., Vol. 51(7), 19-33 (1987). For a minimum required enthalpy of fusion of 300 kJ/kg or greater, the authors postulate the following eutectically melting compounds for the temperature range of 210-360° C.:

LiOH—NaOH, 210° C., 344 kJ/kg

NH4F, 238° C., 340 kJ/kg

LiCl—LiNO3, 244° C., 358 kJ/kg

LiNO3, 250° C., 370 kJ/kg

LiCl—LiOH, 262° C., 437 kJ/kg

KCl—LiCl—LiOH, 280° C., 364 kJ/kg

K2CO3—KOH—LiOH, 309° C., 362 kJ/kg

KOH—LiOH, 314° C., 341 kJ/kg

NaOH, 323° C., 345 kJ/kg

BeF2—NaF, 360° C., 327 kJ/kg.

All these mixtures are either highly corrosive (hydroxide-, chloride- and/or fluoride-containing), toxic (fluoride- and beryllium-containing), fire promoting (nitrate-containing) and/or very expensive (lithium-containing), although the indicated enthalpies of fusion do represent very high values and would make the mixtures predestined for use as latent storage media.

However, such materials would presumably not be usable for industrial implementation for economic reasons, so that a material having a lower enthalpy of fusion combined with otherwise advantageous property values would tend to give greater benefit in power station operation.

### SUMMARY

One embodiment provides a latent energy store based on a change in the state of matter of a storage medium, wherein energy is able to be stored as enthalpy of fusion or as enthalpy of crystallization in the storage medium and the latent heat store is operated at temperatures in the range from 150° C. to 500° C. and the storage medium comprises an acetate of a metal and/or nonmetal having a melting point in the range from 150° C. to 500° C.

In one embodiment, the storage medium comprises an acetate of an alkali metal and/or alkaline earth metal.

In one embodiment, the storage medium comprises a salt mixture comprising a plurality of acetates.

In one embodiment, the storage medium comprises an oxygen scavenger.

In one embodiment, the storage medium displays a volume change of less than 10%, in particular less than 5% and very preferably less than 2.5%, during the phase change.

In one embodiment, the storage medium comprises sodium acetate and potassium acetate in approximately equal amounts, with respect to mole percentage.

In one embodiment, the storage medium contains sodium acetate and/or potassium acetate in anhydrous form.

### DETAILED DESCRIPTION

Embodiments of the present invention provide a latent energy store having a storage medium for the medium temperature range from 150° C. to 500° C., in particular from 200° C. to 350° C., for, for example, power station applications, with the storage medium preferably causing little corrosion and being cheap and available from sustainable sources. Furthermore, the storage medium should have a low toxicity and at the same time a high energy storage capability with little or no tendency to undergo supercooling on solidification.

Some embodiments provide a latent energy store based on a change in the state of matter of a storage medium, wherein energy is able to be stored as enthalpy of fusion or as enthalpy of crystallization in the storage medium and the latent heat store is operated at temperatures in the range from 150 to 500° C. and the storage medium comprises an acetate of a metal and/or nonmetal having a melting point in the range from 150 to 500° C.

The class of acetates, i.e., for example, the alkali metal and/or alkaline earth metal salts of acetic acid, a C1-carboxylic acid, are generally nontoxic, biodegradable, noncorrosive and readily available. Acetic acid itself can be obtained by fermentation of biological material to form ethanol with subsequent oxidation by bacteria and is thus an effectively renewable raw material. That is a sustainable source of acetate.

Industrially, acetic acid can be obtained in high purity by, inter alia, the Monsanto process, i.e. the reaction of methanol with carbon monoxide. Acetic acid is a bulk chemical and is produced in millions of metric tons per year. Sodium acetate, a representative of an alkali metal salt of acetic acid, is prepared, for example, by neutralization of sodium carbonate or sodium hydrogencarbonate with acetic acid and is a cheap and nontoxic bulk chemical.

In one modification, sodium acetate binds three molecules of water of crystallization (CH3COONa▪3H2O, sodium acetate trihydrate). The compound melts incongruently at 58° C. and dissolves completely in its own water of crystallization at 78° C. Longer heating at 80-100° C. results in a supersaturated solution which can then be cooled to room temperature without crystallization occurring. A crystallization nucleus and/or mechanical stress (buckling plate, introduction of sound, impact) then results in spontaneous crystallization from the solution, with the considerable enthalpy of up to 278 kJ/kg in the temperature range around 60° C. being liberated again. This phenomenon is used in “handwarmers” or activatable heat cushions. Sodium acetate trihydrate is a cheap and readily available bulk chemical.

This compound is of course not usable for the temperature range of 200-350° C. because of the crystallization temperature and the pronounced supercoolability.

However, it has surprisingly been found that the material can be dewatered without problems and as sole pure substance has the potential to be the storage medium and a latent energy store.

Anhydrous sodium acetate, i.e. sodium acetate without water of crystallization, melts at 329° C. and, in contrast to the trihydrate, displays virtually no supercooling tendency. This is likewise the case for potassium acetate, which melts at 303° C. The eutectic mixture of sodium acetate and potassium acetate also displays a favorable melting point of 232° C. for the desired temperature range.

The ability of the pure substances and of cation mixtures, in particular of the first main group of the Periodic Table, having a common acetate anion to withstand heat also makes them usable and stable in the relevant temperature range. The inventor has found that the enthalpies of fusion of anhydrous sodium acetate and of the corresponding potassium acetate have hitherto not yet been determined satisfactorily and surprisingly display quite high values of about 210 kJ/kg for anhydrous sodium acetate and about 165 kJ/kg for potassium acetate.

Anhydrous sodium acetate is a nontoxic, noncorrosive and advantageous chemical.

This chemical without water of crystallization has also long been used as compatible deicing substance, in particular at airports for deicing airfoils. The class of substances has been registered worldwide as food additive (in Germany under E262) and is unproblematical to human beings and animals. Dewatering of sodium acetate trihydrate occurs rapidly in the temperature range from 150° C. to about 200° C.

Potassium acetate does not form a species containing water of crystallization and is known as food additive E261 in Germany. While anhydrous sodium acetate displays a volume expansion of +3.90% on melting, potassium acetate has the rare property of undergoing a volume contraction of −1.05% on melting. Blends of sodium acetate and potassium acetate, in particular those having the eutectic formulation, can thus be adjusted so that the volume change is particularly small during melting. This is of great interest in terms of the dimensional stability and the possible degree of fill in a container of a latent energy store.

In the case of mixtures in which sodium acetate and/or potassium acetate is present in anhydrous form, up to 50 mol % of potassium acetate can be present, so that virtually no volume changes occur during the phase transition.

For example, a binary mixture (solid <-> liquid at fixed temperature) of 48+/−2 mol % of anhydrous sodium acetate and 52+/−2 mol % of anhydrous potassium acetate (melting point 235+/−3° C.) is used. This then corresponds to a composition of 43.6+/−2% by weight of sodium acetate and 56.4+/−2% by weight of potassium acetate. This mixture has a volume change during the phase transition of about 1.16+/−0.1%.

As an alternative, a mixture comprising 23.6 mol % of sodium acetate and 76.4 mol % of potassium acetate can be used according to one embodiment of the invention; this corresponds to about 20.5% by weight of sodium acetate and 79.5% by weight of potassium acetate. This mixture has a liquidus temperature of 273° C. (complete melting with commencement of melting at 235° C.)

Blanketing protective gas or dispensing of the storage medium with exclusion of oxygen is particularly beneficial for the surface stability of a metallic container which accommodates anhydrous acetates as storage media. This is advised for liquid acetates since at high temperatures acetates can partly react with oxygen to undergo free-radical rearrangements and a dark coloration due to carbonization can occur. It has been found that handling of the anhydrous material under protective gas, e.g. a stream of nitrogen or argon, during introduction, melting solidification and even maintaining the liquid state at 350° C. for days ensures the stability of the material and prevents discoloration from occurring. It is also conceivable to introduce oxygen scavengers into the container so as to chemically bind the residual oxygen.

The reabsorption of water from the atmosphere at room temperature and open exposure to the environment is only slight or negligible and is not relevant in the closed container.

Embodiments of the invention provide a latent energy store based on a phase change material. In particular, it provides a latent energy store based on a change in the state of matter of a storage medium, wherein energy is able to be stored as enthalpy of fusion or as enthalpy of crystallization in the storage medium and the latent heat store is operated at temperatures in the range from 150 to 500° C. and the storage medium comprises an acetate of a metal and/or nonmetal having a melting point in the range from 150 to 500° C.

What is claimed is:

1. A latent energy store, comprising:
a storage medium comprising a phase change material comprising an acetate of at least one of a metal or a nonmetal and having a melting point in the range from 150 to 500° C.,
the storage medium configured to store energy as enthalpy of fusion or as enthalpy of crystallization, and
wherein the latent heat store is operated at temperatures in the range from 150 to 500° C.

2. The latent energy store of claim 1, wherein the storage medium comprises an acetate of at least one of an alkali metal or an alkaline earth metal.

3. The latent energy store as claimed of claim 1, wherein the storage medium comprises a salt mixture comprising a plurality of acetates.

4. The latent energy store as claimed of claim 1, wherein the storage medium comprises an oxygen scavenger.

5. The latent energy store as claimed of claim 1, wherein the storage medium displays a volume change of less than 10% during a phase change of the storage medium.

6. The latent energy store as claimed of claim 1, wherein the storage medium comprises sodium acetate and potassium acetate in approximately equal amounts, with respect to mole percentage.

7. The latent energy store of claim 1, wherein the storage medium contains at least one of sodium acetate or potassium acetate in anhydrous form.

8. The latent energy store as claimed of claim 1, wherein the storage medium displays a volume change of less than 5% during a phase change of the storage medium.

9. The latent energy store as claimed of claim 1, wherein the storage medium displays a volume change of less than 2.5% during a phase change of the storage medium.
